(19) United States
(12) Patent Application Publication
(10) Pub. No.: US 2011/0001812 A1
(43) Pub. Date: Jan. 6, 2011

(54) Context-Aware Alarm System

(75) Inventors: Pengju Kang, Yorktown Heights, NY (US); Alan M. Finn, Hebron, CT (US); Thomas M. Gillis, Manchester, CT (US); Ollencio D'souza, Farmington, CT (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Chub International Holdings Limited, Farmington, CT (US)

(21) Appl. No.: 11/886,481

(22) PCT Filed: Mar. 15, 2005
(86) PCT No.: PCT/US05/08566

§ 371 Date: Sep. 20, 2010

(51) Int. Cl. H04N 7/18; G08B 21/00

(52) U.S. Cl. 348/77; 340/540; 348/E07.085

(57) ABSTRACT

An alarm system (20) computes a situation context output (30) as a function of information received from sensors (24a-24n). The alarm system (20) extracts contextual information (lₐ-lₙ) related to situation (22) of environment (18) and aggregates contextual information (lₐ-lₙ) using context aggregation (34) to produce situation context output (30).

### BACKGROUND OF THE INVENTION

The present invention relates generally to alarm systems. More specifically, the present invention relates to alarm systems with enhanced performance to reduce nuisance alarms.

In conventional alarm systems, nuisance alarms (also referred to as false alarms) are a major problem that can lead to expensive and unnecessary dispatches of security personnel. Nuisance alarms can be triggered by a multitude of causes, including improper installation of sensors, environmental noise, and third party activities. For example, a passing motor vehicle may trigger a seismic sensor, movement of a small animal may trigger a motion sensor, or an air-conditioning system may trigger a passive infrared sensor.

Conventional alarm systems typically do not have on-site alarm verification capabilities, and thus nuisance alarms are sent to a remote monitoring center where an operator either ignores the alarm or dispatches security personnel to investigate the alarm. A monitoring center that monitors a large number of premises may be overwhelmed with alarm data, which reduces the ability of the operator to detect and allocate resources to genuine alarm events.

As such, there is a continuing need for alarm systems that reduce the occurrence of nuisance alarms.

### BRIEF SUMMARY OF THE INVENTION

With the present invention, contextual information is extracted from sensor signals of an alarm system monitoring an environment. A contextualized alarm output representative of a situation associated with the monitored environment is produced as a function of the extracted contextual information.

### BRIEF DESCRIPTION OF THE DRAWINGS

FIG. 1 is a block diagram of a conventional alarm system.

FIG. 2 is a block diagram of an embodiment of an alarm system of the present invention including an alarm panel for producing a situation context output as a function of information received from sensors.

FIG. 3 is a flow diagram of a context aggregation process for use by the alarm panel of FIG. 2 to produce the situation context output of FIG. 2.

FIG. 4 is a block diagram of a sensor fusion algorithm for generating an alarm decision as a function of sensor signals received from conventional sensors.

FIG. 5 illustrates a method for fusing the situation context output of FIG. 2 and the alarm decision of FIG. 4.

FIG. 6 shows an example of an alarm system of FIG. 2 for producing the situation context output of FIG. 2.

FIG. 7 is a block diagram of a smart badge for use with the alarm system of FIG. 6.

### DETAILED DESCRIPTION

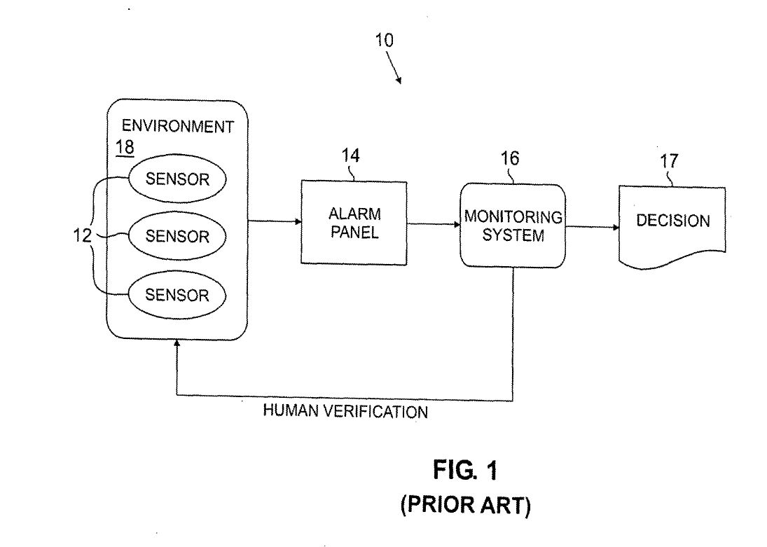

FIG. 1 shows conventional alarm system 10, which includes conventional sensors 12, conventional alarm panel 14, and remote monitoring system 16. Conventional sensors 12 monitor environment 18 and are in communication with alarm panel 14. Pursuant to industry standards, each conventional sensor 12 sends a binary sensor signal to alarm panel 14, with a “0” indicating a negative detection of an alarm event and a “1” indicating a positive detection of an alarm event. For example, if one of sensors 12 is a motion detector and a motion occurs within environment 18, a “1” is communicated to alarm panel 14 to indicate detection of an alarm event. Notification of this alarm event is received by alarm panel 14, which in turn communicates occurrence of the alarm event to remote monitoring system 16.

In most situations, remote monitoring system 16 is an off-site call center, staffed with a human operator, that monitors a multitude of conventional alarm panels 14 located at a multitude of different premises. Conventional alarm panels 14 communicate alarm data to remote monitoring system 16, which typically appear as text on a computer screen, or a symbol on a map, indicating that a sensor has detected an alarm event. Conventional alarm systems 10 do not provide contextual information about the facts and circumstances surrounding alarm events, and thus every alarm event must be treated as genuine. This lack of contextual information about the facts and circumstances surrounding an alarm event impairs the ability of remote monitoring system 16 to efficiently allocate security resources to simultaneous alarms.

With a conventional system such as alarm system 10, before making decision 17 about the truth of an alarm event, security personnel must investigate the alarm event to verify whether the alarm event is a nuisance alarm event or a genuine alarm event. The need for conducting an investigation is necessitated by a lack of contextual information about the situation responsible for causing the alarm event. Such investigations can entail visiting the premises in which the alarm event occurred or viewing the premises via remote viewing equipment. The alarm system of the present invention can reduce or eliminate the need for security personnel to conduct such investigations to determine whether an alarm event is genuine.

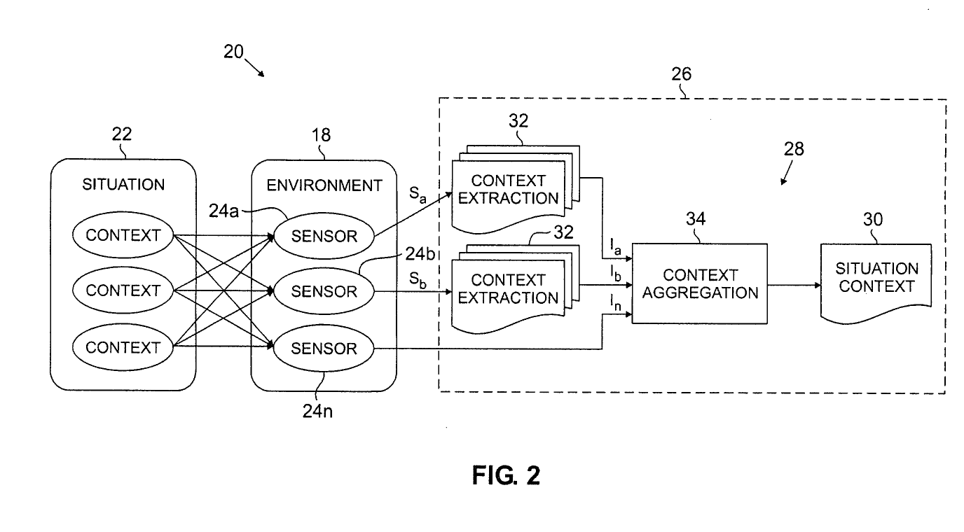

FIG. 2 shows alarm system 20 of the present invention for monitoring environment 18 that is capable of extracting contextual information about situations 22 occurring within environment 18. Alarm system 20 uses the extracted contextual information to assess (or verify) whether an alarm event detected by alarm system 20 is a nuisance alarm event or a genuine alarm event. In some embodiments, the contextual information is used to filter out false positives (also referred to as nuisance alarms or false alarms) and prioritize allocation of security or maintenance personnel to respond to various alarms.

As shown in FIG. 2, alarm system 20 includes sensors 24a-24n (where n represent the number of sensors) and alarm panel 26. Sensors 24a-24n are deployed in environment 18 to monitor situations 22 occurring within environment 18 and communicate sensor signals Sₐ-Sₙ representing conditions associated with situation 22 to inputs of alarm panel 26. In the embodiment of FIG. 2, alarm panel 26 then executes context algorithm 28, which produces situation context output 30 as a function of sensor signals Sₐ-Sₙ. As shown in FIG. 2, sensors 24a and 24b are conventional sensors similar to conventional sensors 12 of FIG. 1 and sensor 24n is a smart sensor. Alarm system 20 can include any number and combination of conventional sensors and smart sensors. As used herein, the term “smart sensor” is defined to include sensors that have on-board intelligence (e.g., such as a data processor) for extracting contextual information from raw sensor data generated by the sensors.

In the embodiment of FIG. 2, context algorithm 28 includes context extractions 32 and context aggregation 34, which are functional steps executed by a data processor included in alarm panel 26. Sensors signals Sₐ and S_{b} from sensors 24a and 24b are inputted into context extractions 32, which extract contextual information Iₐ and I_{b} relating to situation 22. Smart sensor 24n extracts contextual information Iₙ from its own raw sensor data and communicates contextual information Iₙ to alarm panel 26. Contextual information Iₐ-Iₙ is input to context aggregation 34, which produces situation context output 30 as a function of contextual information Iₐ-Iₙ. Context aggregation 34 computes situation context output 30 from all available contextual information Iₐ-Iₙ and excludes any context elements (or cues) contained within contextual information Iₐ-Iₙ that it determines to be irrelevant. Examples of algorithms for use in context aggregation 34 include rule-based algorithms, fuzzy logic, statistical methods and neural networks.

Situation context output 30 describes or characterizes situation 22 of environment 18 for decision-making purposes by alarm panel 26 or remote monitoring system 16. For example, situation context output 30 may include a location of an activity, a nature of an activity, an identity of a person associated with an activity, a state of environment 18, or combinations of these. In most embodiments, context output 30 is a contextualized alarm message that is directly actionable by security or maintenance personnel. Examples of such contextualized alarm messages include “two unknown people entering building illegally at entrance X”, “motion alarm triggered by 3 human intruders in zone X”, “4 people acting suspiciously detected”, “1 human intruder breaking into the safe”, or “door sensor at location X is faulty and in need of repair”.

Contextual information Iₐ-Iₙ includes one or more context elements, which can be of a variety of forms. Examples of such context elements include statistical information (e.g., a duration of an alarm or a frequency of an alarm over time), spatial/temporal information (e.g., a location of a particular sensor 24a-24n within environment 18 or a location of a particular sensor 24a-24n relative to other sensors 24a-24n or to layout features of environment 18), user information, an acceleration of an object, a number of objects entering or exiting an area, whether an object is a person, a speed of an object, a direction of a movement, an identity of a person, a size of a person, an intention of a person, an identity of possible attack tools, or combinations of these. The nature and number of context elements that can be extracted from a particular sensor 24 depends upon the particular type of sensor.

Any type of conventional sensor or smart sensor may be used with alarm system 20. Examples of sensors 24 for use in alarm system 20 include portable identification devices, motion sensors, temperature sensors, seismic sensors, access readers, scanners, conventional video sensors, video sensors equipped with or in communication with video content analyzers, oxygen sensors, global positioning (GPS) devices, accelerometers, microphones, heat sensors, door contact sensors, proximity sensors, pervasive computing devices, and any other security/alarm sensor known in the art. These sensors can provide information to alarm panel 26 in the form of a “detect” (e.g., “1”) or “no detect signal” (e.g., “0”), raw sensor data (e.g., temperature data from a temperature sensor), contextual information, or combinations of these.

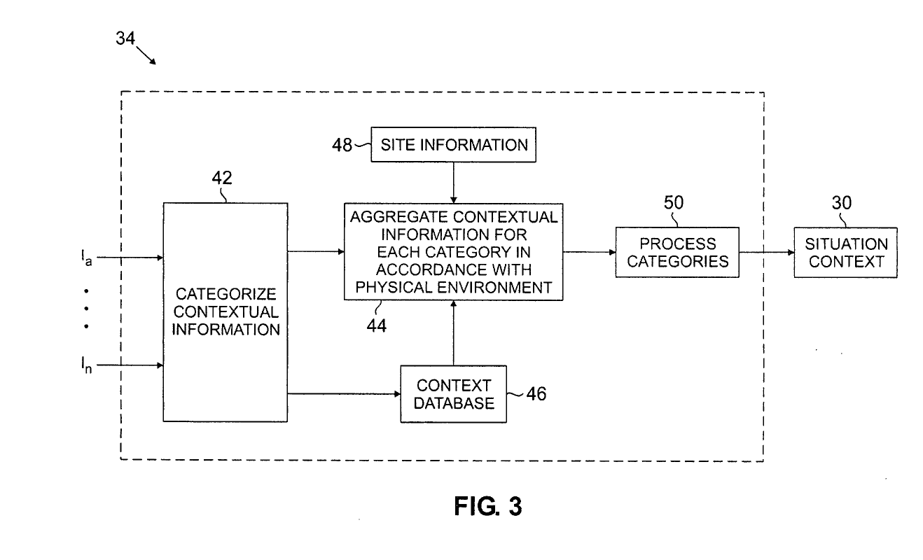

FIG. 3 is a flow diagram illustrating one embodiment of context aggregation 34 of FIG. 2 for processing contextual information Iₐ-Iₙ to produce situation context output 30. As shown in FIG. 3, contextual information Iₐ-Iₙ is input to context aggregation 34 which categorizes the contextual information into various categories (step 42) such as, for example, user-behavior context categories, environmental context categories, activity context categories, device context categories, and historical context categories. This categorization of contextual information Iₐ-Iₙ results in the association of contextual information Iₐ-Iₙ from various sources, which enhances the reliability of contextual information Iₐ-Iₙ. The contextual information included in each category is then further aggregated (step 44) in accordance with historical context data received from context database 46, site information 48 associated with environment 18, and dependencies (or interrelationships) existing among contextual information Iₐ-Iₙ.

After aggregation in step 44, the aggregated categories are then further processed (step 50) to yield situation context output 30. In some embodiments, the context information from different categories is further fused using a context manipulation technique in accordance with the dependencies existing among the contextual information using methods such as set theory, direct graph, first order logic, and composite capability/preference profiles, or any other method known in the art. In some embodiments, subjective belief models are used in context aggregation 34 to quantify contextual information Iₐ-Iₙ and/or categories and enhance the reliability of situation context output 30. For example, in some embodiments, each category represents a possible context scenario occurring within environment 18 and an opinion measure is computed for each context scenario. These opinion measures are then used to assess the probability of each context scenario and eliminate context scenarios with low probabilities. Examples of such context scenarios include access violations, intrusion, attack of protected assets, and removal of protected assets. In some embodiments, particularized subsets of these context scenarios relevant to the particular environment 18 being monitored can be included in the categorization process.

The below discussion of categories for use in step 42 is included to further illustrate some of the example categories referenced above. A multitude of additional categories (or variations of the above categories) can also be considered by context aggregation 34, depending upon the particular security needs of environment 18. In some embodiments, some or all of the categories of step 42 are user-defined.

### User Behavior Context Categories

User behavior context categories describe user-behaviors that are associated with an alarm event. Examples of contextual information for classification in a user behavior category include a number of user(s), an identity of a user(s), a status of a user(s) (e.g., authorized vs. non-authorized), a tailgating event, and a mishandling of alarm system 20 by a user(s) (e.g., failure to arm/disarm). Examples of sources of such contextual information include access control devices, smart badges, hand held devices, facial recognition systems, iris readers, walking gesture recognition devices, hand readers, and video behavior analysis systems.

### Activity Context Categories

Activity context categories describe specific activities associated with an alarm event. Examples of such activity categories include intrusion, access, property damage, and property removal. Examples of contextual information that may be categorized in such activity context categories include a type of an event, a time of an event, user activities (e.g., an authorized user working late), third party activities (e.g., a cleaning crew working), an intruder breaking into a protected area of environment 18, a protected asset being removed or damaged, and abnormal behaviors (e.g., loitering, sudden changes in speed, people congregating, and person(s) falling). Examples of sources of such contextual information include site models (e.g., information about the physical layout of environment 18), accelerometers, pressure sensors, temperature sensors, oxygen sensors, global positioning devices, motion sensors, and video sensors with video content analysis.

### Environmental Context Categories

Examples of contextual information that may be categorized into environmental context categories include a location of a detected object(s) within environment 18 and a proximity of a detected object(s) to a protected area or asset within environment 18. Examples of sources of such contextual information include sensors for measuring ambient conditions of environment 18, historical records of ambient conditions of environment 18, site models (e.g., physical layout information for environment 18), accelerometers, pressure sensors, temperature sensors, oxygen sensors, global positioning devices, motion sensors, and video sensors with video content analysis

### Device Context Categories

Device context categories generally describe a condition or health of a device or an identity or other characteristic of a person using a device. Device diagnostics and statistical data (e.g., alarm frequency, sensor alarm duration, and sensor alarm time) can be used to infer a health of a sensor. In some situations, device context categories can be used by context aggregation 34 to filter out nuisance alarms due to device malfunctions and produce situation context outputs 30 to notify maintenance personnel of maintenance issues. In some embodiments, if a sensor continues to indicate detection of an alarm event and no other sensors indicate any changes in environment 18, then the sensor is deemed faulty and data from the sensor is automatically discounted by context aggregation 34. A device context category may play an important role, for example, when a passive infrared (PIR) motion sensor that frequently detects alarm events sends a motion alarm to alarm panel 26. Given the history of the PIR motion sensor for sending motion alarms, alarm panel 26 can use a health-related device category to assess the reliability of the PIR motion alarm. If, for example, no movement patterns are identified by other nearby motion sensors and a nearby temperature sensor detects a high environment temperature but no fire or smoke alarm is received, then the PIR motion alarm can be deemed false by alarm panel 26 due to the fact that PIR motion sensors are less reliable at high ambient temperatures.

### Historical Context Categories

Historical categories describe historical contexts related to environment 18 that can be used to affirm or disaffirm contextual information Iₐ-Iₙ or categories for inclusion in context aggregation 34. Sources of contextual information for categorization in historical categories include, for example, historic security data for alarm events occurring within environment 18, weather patterns, and crime rates.

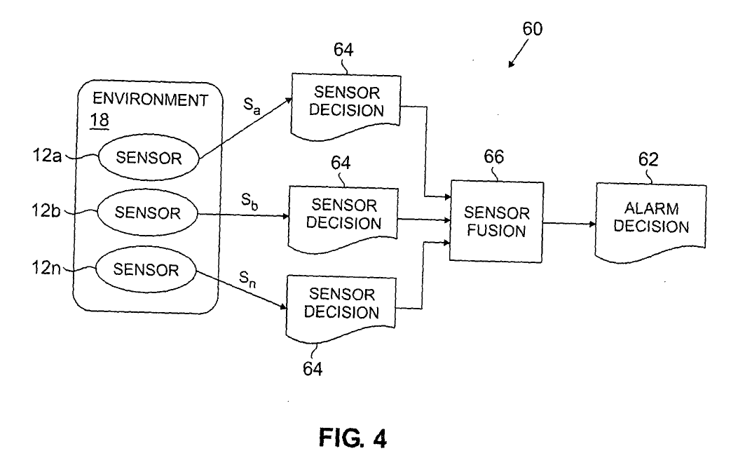

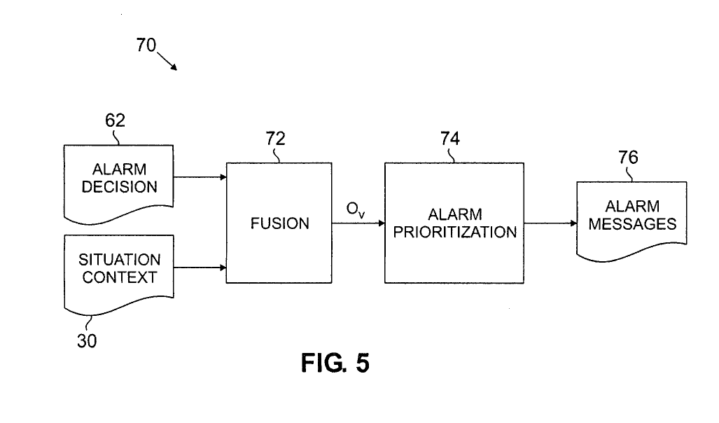

FIG. 4 is a flow diagram illustrating sensor fusion architecture 60 of the present invention for generating alarm decision 62 as a function of information received from multiple conventional sensors 12 of FIG. 1 deployed in environment 18. Sensor fusion architecture 60 integrates the decisions of multiple conventional sensors 12a-12n (where n is the number of conventional sensors 12) to obtain a single decision. As discussed below in relation to FIG. 5, sensor fusion architecture 60 can be used to enhance the reliability of situation context output 30 of FIG. 2.

To generate alarm decision 62, alarm panel 26 of FIG. 2 uses a subjective belief model to process each conventional sensor signal Sₐ-Sₙ and generate a series of sensor decisions 64 corresponding to each conventional sensor 12a-12n. Sensor fusion 66 then fuses sensor decisions 64 to produce alarm decision 62. In some embodiments (e.g., see FIG. 5), alarm decision 62 is then fused with situation context output 30 to improve the reliability of situation context output 30.

In some embodiments, each of sensor decisions 64 represent an opinion ωₓ about the truth of an alarm event x expressed in terms of belief, disbelief, and uncertainty in the truth of alarm event x. As used, herein, a “true” alarm event is defined to be a genuine alarm event that is not a nuisance alarm event. The relationship between these variables can be expressed as follows:

bₓ+dₓ+uₓ=1, (Equation 1)

where bₓ represents the belief in the truth of event x, dₓ represents the disbelief in the truth of event x, and uₓ represents the uncertainty in the truth of event x.

Values for bₓ, dₓ, and uₓ are assigned based upon, for example, empirical testing involving conventional sensors 12a-12n and environment 18. In addition, predetermined values for bₓ, dₓ, and uₓ for a given sensor 12a-12n can be assigned based upon prior knowledge of that particular sensor's performance in environment 18 or based upon manufacturer's information relating to that particular type of sensor. For example, if a first type of sensor is known to be more susceptible to generating false alarms than a second type of sensor, the first type of sensor can be assigned a higher uncertainty uₓ, a higher disbelief dₓ, a lower belief bₓ, or combinations of these.

An opinion ωₓ having coordinates (bₓ,dₓ,uₓ) can be projected onto a 1-dimensional probability space by computing probability expectation value E(ωₓ), which is defined by the equation

E(ωₓ)=aₓ+uₓbₓ, (Equation 2)

where aₓ is the decision bias, uₓ is the uncertainty, and bₓ is the belief. Decision bias aₓ can be defined by a user to bias the alarm system towards either deciding that an alarm event is a genuine alarm event or a nuisance alarm event.

Sensor fusion 66 can use various fusion operators in various combinations to fuse sensor decision 64. Examples of such fusion operators include multiplication, co-multiplication, counting, discounting, recommendation, consensus, and negation. In some embodiments, co-multiplication operators can function as “or” fusion operators while multiplication operators can function as “and” fusion operators. For example, the multiplication of two sensor decisions 64 having coordinates (0.8,0.1,0.1) and (0.1,0.8,0.1), whereby each sensor decision 64 is an opinion ωₓ triplet (bₓ,dₓ,uₓ), yields a fused opinion of (0.08,0.82,0.10), whereas the co-multiplication of the two sensor decision 64 yields a fused opinion of (0.82,0.08,0.10).

The above subjective belief modeling methods, as well as other belief modeling methods, can be used in conjunction with any fusion method of the present invention. For example, some embodiments of context aggregation 34 incorporate such belief modeling methods in computing situation context output 30.

FIG. 5 shows a flow diagram illustrating alarm process 70 of the present invention for fusing situation context output 30 of FIG. 2 and alarm decision 62 of FIG. 4 to produce a verified context alarm output Oᵥ. The fusion of alarm decision 62 and situation context output 30 provides a cost effective means for enhancing the ability of alarm system 20 to filter out nuisance alarms and provide context opinion outputs with reduced uncertainty, while minimizing the number of smart sensors. In addition, FIG. 5 illustrates one method of the present invention in which situation context information can be used to prioritize alarm messages.

As shown in FIG. 5, alarm decision 62 and situation context output 30 are input into fusion 72, which produces verified context output Oᵥ as a function of alarm decision 62 and situation context output 30. In most embodiments, fusion 72 is executed by alarm panel 26 to produce verified context output Oᵥ, which is then packaged by alarm panel 26 in a format for remote transmission to remote monitoring system 16. In some embodiments, situation context output 30 and alarm decision 62 are communicated to remote monitoring system 16, which executes fusion 72 to produce verified context output Oᵥ.

As shown in FIG. 5, verified context output Oᵥ, after being received by remote monitoring system 16, is prioritized relative to other alarm messages received by remote monitoring system 16. Using situation context information included in verified context output Oᵥ, alarm prioritization 74 prioritizes verified context output Oᵥ relative to other alarm messages. Based on alarm prioritization 74, remote monitoring system 16 can then direct first responders with minimal delay to respond to alarm messages 76 of the highest priority. In some circumstances, verified context output Oᵥ may be sent directly from alarm panel 26 to a first responder.

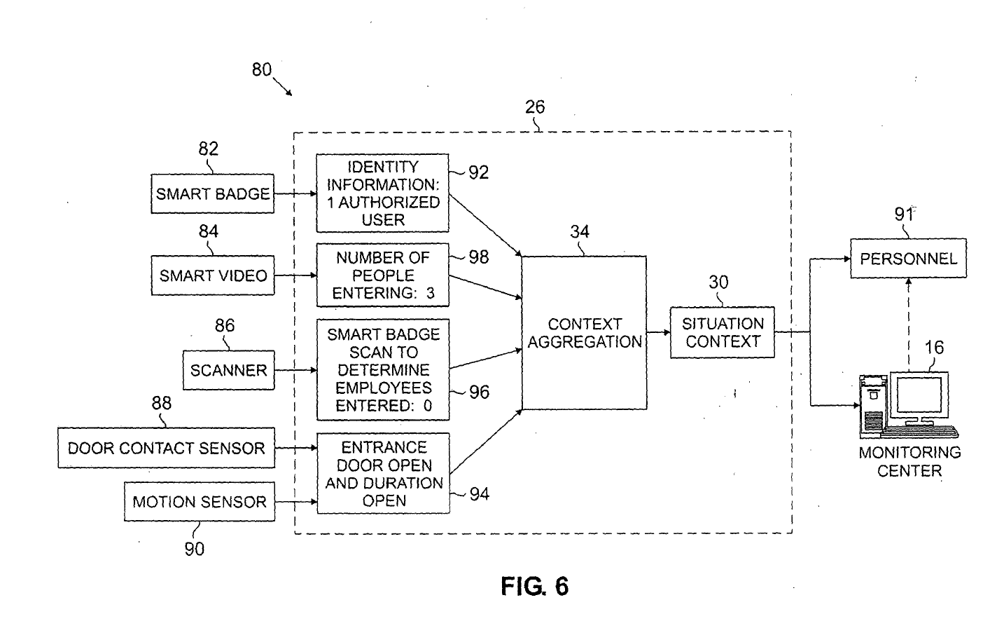

FIG. 6 shows alarm system 80 of the present invention, which is an example of alarm system 20 of FIG. 2. Alarm system 80 is configured to monitor an entry point (such as a door) of environment 18 and detect access violations such as, for example, tailgating (e.g., more than one person entering per identity card) and piggybacking (e.g. when a valid owner of an identity card passes the card to others to affect their entry) and user errors such as failure to arm or disarm alarm system 80 after exit or entry. As shown in FIG. 6, alarm system 80 includes alarm panel 26 and a combination of smart sensors and conventional sensors 12—namely, smart badge 82, smart video sensor 84, scanner 86, door contact sensor 88, and motion sensor 90. As a function of information received from these sensors, alarm system 80 generates situation context output 30, which it communicates either directly to remote monitoring center 16 or to personnel 91 (either maintenance or security) for dispatch to environment 18.

FIG. 6 illustrates an example of alarm system 80 using contextual information to detect a tailgating event. A user presents smart badge 82, which is a portable identity recognition device, to a card reader (not shown). Smart badge 82 determines that the user is authorized for access and authorizes the card reader to grant access to the user. The identity of the user is then reported to the alarm panel (block 92). Door contact sensor 88 then registers the user opening the entrance door to gain access to environment 18 (block 94). Smart video sensor 84 monitors the door to determine the number of people entering (block 96). In addition, alarm panel 26 monitors data received from door contact sensor 88 and motion sensor 90 to verify that the door is not intentionally kept open (block 94). If more then one person is detected entering through the door, scanner 86 (which in some embodiments is a radio frequency identification (RFID) scanner) scans the area to determine if the tailgaters have smart badges 82 on their persons (block 98). If the two tailgaters have smart badges 82, the identities of the two tailgaters are obtained using the identity data sent back from the smart badges and the names of the tailgaters are reported, for example, to the building manager. If the tailgaters do not have any recognizable identification cards, then situation context output 30, in the form of an intrusion alarm, is communicated to remote monitoring system 16 or personnel 91. The intrusion alarm could be a contextualized alarm message such as, for example, “two unknown people entered the building illegally, and the current location of the intruder is at the entrance.” Once the tailgaters have entered environment 18, alarm panel 26 can direct other video sensors within environment 18 to track further movements of the tailgaters within environment 18.

In some embodiments, smart video sensor 84 includes facial recognition capabilities to capture the facial images of persons granted access to environment 18. These facial images can be used by alarm system 80 at a later time to determine user errors and filter out resulting nuisance alarms. In some embodiments, smart video sensor 84 includes a video content analyzer to extract contextual features from video data. In some embodiments, smart video sensor 84 includes voice and/or noise pattern recognition capabilities to allow standard voice commands or unusual noise patterns to be used to reinforce detection accuracy. In some embodiments, smart video sensor 84 communicates with one or more sensors and is activated by the other sensor(s).

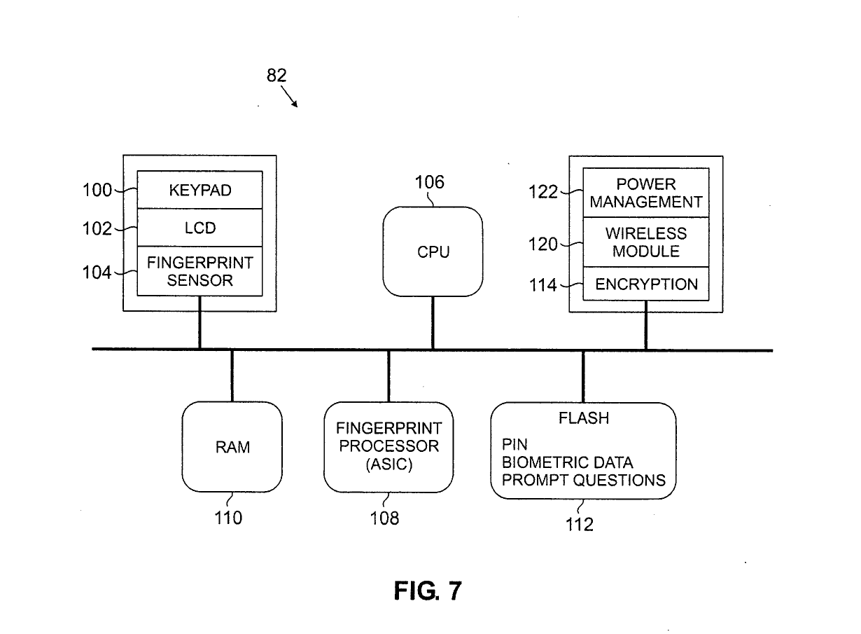

FIG. 7 shows a block diagram illustrating the functional components of smart badge 82 of FIG. 6. As shown in FIG. 7, identity recognition badge 82 includes keypad 100, liquid crystal display (LCD) 102, fingerprint sensor 104, microprocessor 106, fingerprint processor 108, random access memory (RAM) 110, flash memory 112, encryption circuitry 114, wireless communication module 120, and power management circuitry 122. Each smart badge 82 has a unique identification. Unlike conventional proximity cards, smart badge 82 uses a personal identification number (PIN) and/or biometric data to verify the identity to the user. As such, unlike conventional proximity cards, the mere possession of smart badge 82 by a user does not automatically afford that user access to a secured area. As shown in FIG. 7, a PIN is stored in flash memory 112 along with biometric data (e.g., fingerprint data) associated with the intended user of smart badge 82.

In one embodiment, to gain access to a restricted area, a user must present smart badge 82 to an access reader and enter a PIN using keypad 100. Smart badge 82 compares the-user entered PIN with a reference PIN stored in flash memory 112. If the user-entered PIN matches the reference PIN, then wireless communication module 120 sends an encrypted command to the access reader and access to the restricted area is granted. If these two PINs do not match, then LCD 102 can display one or more prompt questions to verify the identity of the user and/or remind the user of the reference PIN. These prompt questions can be programmed in smart badge 82 in advance according to the preference of a user.

In another embodiment of smart badge 82, biometric data is used to verify the identity of a user. For example, upon presenting smart badge 82 to an access reader, a user presses a finger onto fingerprint sensor 104. Fingerprint processor 108 then compares the scanned fingerprint to a reference fingerprint stored in flash memory 112 to verify the identity of the user. As shown in FIG. 7, finger print processor 108 is an application-specific integrated circuit (ASIC). In some embodiments, both biometric data and a PIN are used to verify the identity of a user of smart badge 82.

In some embodiments of the present invention, whether a contextualized alarm output such as situation context output 30 is transmitted to remote monitoring system 16 depends upon the probability and uncertainty associated with the contextualized alarm output. Depending upon the uncertainty level associated with the contextualized alarm output, in some embodiments, video data can be attached to the contextualized alarm output for live video verification of an alarm event at remote monitoring station 16. In some circumstances, the contextualized alarm output is automatically sent to remote monitoring system 16 without accompanying video data. This can occur, for example, when the contextualized alarm output includes opinion measures having a high probability of belief in the truth of an alarm event and/or a low uncertainty in the truth of the alarm event. Conversely, when the contextualized alarm output has a high uncertainty in a truth of an alarm event and/or a low belief in a truth of an alarm event, the contextualized alarm output is sent to remote monitoring system 16 along with video data to facilitate visual alarm verification and reduce nuisance alarms. In such situations, the bandwidth of communication is optimized for data transmission from alarm panel 26 to remote monitoring system 16. Such optimizations may include reducing the video data to one or more snapshots.

As described above with respect to exemplary embodiments, the alarm system of the present invention is capable of extracting contextual information associated with an alarm event to filter out nuisance alarms, facilitate maintenance actions, and/or assist in allocating security resources in response to various alarm events. In some embodiments, the alarm system of the present invention includes one or more smart sensors with on-board intelligence for extracting contextual information for communicating to an alarm panel.

Although the present invention has been described with reference to preferred embodiments, workers skilled in the art will recognize that changes may be made in form and detail without departing from the spirit and scope of the invention.

1. An alarm system for monitoring an environment and generating a contextualized alarm output in response to an alarm event, the alarm system comprising:
a plurality of sensors to monitor the environment and produce sensor signals representative of a situation associated with the alarm event;
means for extracting contextual information about the situation from the sensor signals;
means for generating a contextualized alarm output as a function of the contextual information; and
communication circuitry for communicating the contextualized alarm output.

2. The alarm system of claim 1, wherein the means for extracting the contextual information comprises a data processor.

3. The alarm system of claim 2, wherein the data processor is located in an alarm panel.

4. The alarm system of claim 2, wherein the data processor is located in one of the plurality of sensors.

5. The alarm system of claim 1, wherein the means for generating the contextualized alarm output comprises a data processor located in an alarm panel.

6. The alarm system of claim 1, wherein at least one of the plurality of sensors comprises a video sensor capable of extracting contextual information related to the situation.

7. The alarm system of claim 1, wherein at least one of the plurality of sensors comprises a portable identity recognition device adapted to extract contextual information about a user of the identity recognition device.

8. An alarm system for monitoring an environment, the alarm system comprising:
a plurality of sensors to monitor the environment and generate sensor signals representative of conditions associated with the environment; and
a local alarm panel comprising:
inputs for communicating with the plurality of sensors to receive the sensor signals from the sensors;
a data processor in communication with the inputs to receive the sensors signals and produce a contextualized alarm output as a function of the sensor signals; and
communication circuitry in communication with the data processor for communicating the contextualized alarm output.

9. The alarm system of claim 8, wherein at least one of the sensor signals includes contextual information produced by one of the plurality of sensors.

10. The alarm system of claim 8, wherein the data processor extracts contextual information from the sensor signals and produces the contextualized alarm output as a function of the contextual information.

11. The alarm system of claim 8, wherein the contextualized alarm output includes diagnostic information related to health of the alarm system.

12. The alarm system of claim 8, wherein at least one of the plurality of sensors comprises a smart sensor equipped with on-board intelligence for extracting contextual information from sensor data.

13. The alarm system of claim 12, wherein the smart sensor comprises a portable identity recognition device that provides contextual information about a user of the identity recognition device.

14. The alarm system of claim 13, wherein the identity recognition device includes a fingerprint scanner.

15. The alarm system of claim 13, wherein the identity recognition device includes a keypad.

16. A method for enhancing performance of an alarm system including a plurality of sensors deployed in an environment, the method comprising:
monitoring the environment with the plurality of sensors and producing sensor signals representative of conditions associated with the environment;
detecting an alarm event based on at least one of the sensor signals;
extracting contextual information from the sensor signals relating to conditions associated with the alarm event; and
producing a contextualized alarm output as a function of the contextual information.

17. The method of claim 16, and further comprising:
transmitting the contextualized alarm output to a remote monitoring system.

18. The method of claim 17, wherein the contextualized alarm output is transmitted to the remote monitoring system only if the contextualized alarm output indicates that the alarm event is a true alarm event.

19. The method of claim 16, and further comprising:
transmitting the contextualized alarm output to a first responder.

20. The method of claim 16, and further comprising:
prioritizing the contextualized alarm output relative to other alarm outputs.
